(19) United States
(12) Patent Application Publication
(10) Pub. No.: US 2020/0200584 A1
(43) Pub. Date: Jun. 25, 2020

(54) SYSTEM AND METHOD FOR LEVEL MEASUREMENT USING FREQUENCY AND PHASE SHIFT

(71) Applicant: Endress+Hauser SE+Co. KG, Maulburg (DE)

(72) Inventor: Gautham Karnik, Whitestown, IN (US)

(21) Appl. No.: 16/230,303

(22) Filed: Dec. 21, 2018

(51) Int. Cl. G01F 23/00; G01F 23/292; H04L 27/36

(52) U.S. Cl. CPC G01F 23/0061; H04L 27/36; G01F 23/2928

(57) ABSTRACT

A method for determining a level of a medium in a container includes steps of generating a first transmitting signal having a first predetermined frequency and transmitting the first transmitting signal toward the medium. The method also includes steps of receiving a first reflected signal from the medium that corresponds to the first transmitting signal, and determining a phase difference between a phase of the first transmitting signal and a phase of the first reflected signal. The method further includes a step of determining the level of the medium based on the first predetermined frequency and the phase difference.

### TECHNICAL FIELD

The present disclosure relates generally to a system and method for determining the level of a medium in a container.

### BACKGROUND

In many industrial applications, an important element of process control is determining how much liquid, gas, or bulk materials, for example, is present in a given container. As such, level measurement devices, including transmitters, are a crucial tool for monitoring the fill level of containers, tanks, or vessels. There exist a number of different kinds of level measurement devices, including those that use capacitance, hydrostatics, magnetism, radar, and ultrasonic technologies. However, none of these measuring technologies is suited for all applications. Therefore, measuring systems must be selected that work reliably under the conditions of a particular application and comply with any economic constraints.

Accordingly, there remains a need for further contributions in this area of technology.

### SUMMARY

According to at least one aspect of the present disclosure, to solve these problems with the current state of the art, the present disclosure discloses a system and method for determining the level of a medium in a container using frequency and phase shift.

According to one aspect, a method for determining a level of a medium in a container includes steps of generating a first transmitting signal having a first predetermined frequency and transmitting the first transmitting signal toward the medium. The method also includes steps of receiving a first reflected signal from the medium that corresponds to the first transmitting signal, and determining a phase difference between a phase of the first transmitting signal and a phase of the first reflected signal. The method further includes a step of determining the level of the medium based on the first predetermined frequency and the phase difference.

According to another aspect, a system for determining a level of a medium in a container includes a frequency generator for generating a first transmitting signal having a first predetermined frequency, and a transmitter for transmitting the first transmitting signal toward the medium. A phase detector receives the first transmitting signal as a first reference signal, and a receiver for receiving a first reflected signal from the medium that corresponds to the first transmitting signal. The phase detector also determines a phase difference between a phase of the first reference signal and a phase of the first reflected signal. A controller determines the level of the medium based on the first predetermined frequency and the phase difference.

### BRIEF DESCRIPTION OF THE DRAWINGS

The described embodiments and other features, advantages, and disclosures contained herein, and the manner of attaining them, will become apparent and the present disclosure will be better understood by reference to the following description of various embodiments of the present disclosure taken in conjunction with the accompanying drawings.

FIG. 1 shows a schematic view of a container equipped with a level sensing system, according to one embodiment of the present disclosure;

FIG. 2 shows a block diagram of the level sensing system of FIG. 1; and

FIG. 3 shows a flowchart of an exemplary method for determining the level of a medium in a container using the level sensing system of the previous FIGS., according to an embodiment of the present disclosure.

### DETAILED DESCRIPTION

The present disclosure discloses systems and methods for determining the level of a medium in a container. At least one embodiment will now be presented in conjunction with the figures which illustrate the embodiments. It will be understood that no limitation of the scope of this disclosure is thereby intended.

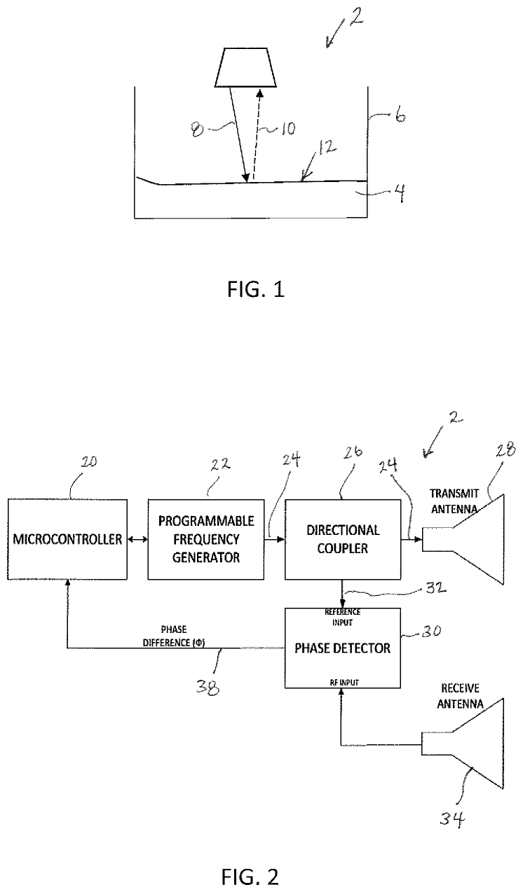

FIG. 1 shows a system 2 for determining a level of a medium 4 in a container 6. The medium 4 may be any substance, including liquids, gases, and bulk materials, such as those used in industrial applications, and the container 6 may be a container of any size, shape, and material. The system 2, or components thereof, may be positioned on or at the container 6 to determine the level of the medium 4 according to a method described herein. Broadly speaking, the system 2 may be configured to generate radio-frequency signals and transmit the radio-frequency signals, including a transmitting signal 8, toward the medium 4. The transmitting signal 8 is reflected back as a reflected signal 10, or echo signal, by a surface 12 of the medium 4 and used by the system 2 to determine the level of the medium 4.

The system 2, as shown in greater detail in FIG. 2, includes a controller 20, or microcontroller, for controlling operation of the system 2, or components and/or features thereof. The controller 20 may include interconnected electronic equipment for controlling the operation and may include input/output devices, processing devices, storage devices, and various other hardware and/or software devices. The controller 20 may include functionality for monitoring and/or controlling various industry applications including, for example, regulation of flow, temperature, pressure, and level.

Based on instructions from the controller 20, a programmable frequency generator 22 may generate signals having predetermined frequencies. For example, the programmable frequency generator 22 may be configured to generate a first transmitting signal 24 having a first predetermined frequency. A directional coupler 26 may receive the first transmitting signal 24 and provide it to one or both of a transmit antenna 28, or waveguide, and a phase detector 30. Information regarding the first transmitting signal 24 may be stored in electronic storage accessible by the controller 20, phase detector 30, and/or another device. This may occur continuously or at predetermined intervals and may include the use of one or more different frequencies.

The transmit antenna 28, which may be a transceiver, then transmits the first transmitting signal 24 toward the medium 4. As stated above, the phase detector 30 may also receive the first transmitting signal 24, which may be used by the phase detector 30 or another device as a first reference signal 32. The first transmitting signal 24 may be reflected, or echoed, from the surface 12 of the medium 4 as a first reflected signal 36, which is received by a receive antenna 34, which may be a transceiver. The receive antenna 34 may receive the first reflected signal 36 corresponding to the first reference signal 32 and transmit the first reflected signal 36 to the phase detector 30. It should be appreciated that various devices, including amplifiers, filters, conditioning devices, and the like, may be included in the system 2.

A phase difference 38, or shift, between a phase of the first transmitting signal 24 and a phase of the first reflected signal 36 may be determined at the phase detector 30 and/or the controller 20. The phase difference 38 may be stored in a memory accessible by the controller 20 and/or the phase detector 30 and may be used to determine the level of the medium 4 in the container 6. That is, the level of the medium 4 may be determined based on the first predetermined frequency of the first transmitting signal 24 and the phase difference. More particularly, the phase difference 38, or shift, is dependent on the frequency and the level of medium 4. Further, the phase shift may be directly proportional to the time of flight, with the phase shift being a times the time of flight times the frequency. Thus, knowledge of the frequency and the phase shift may be used to determine the level.

While receiving the first reflected signal 36 at the receive antenna 34, the transmit antenna 28 may continue to transmit the first transmitting signal 24. As such, the phase difference 38 between the first reflected signal 36 and the first transmitting signal 24 may be determined in near real-time, such as by the phase detector 30. As described below, the system 2 and method of the present disclosure may include the generation and use of signals having different frequencies, such as by generating a frequency sweep of a range of frequencies.

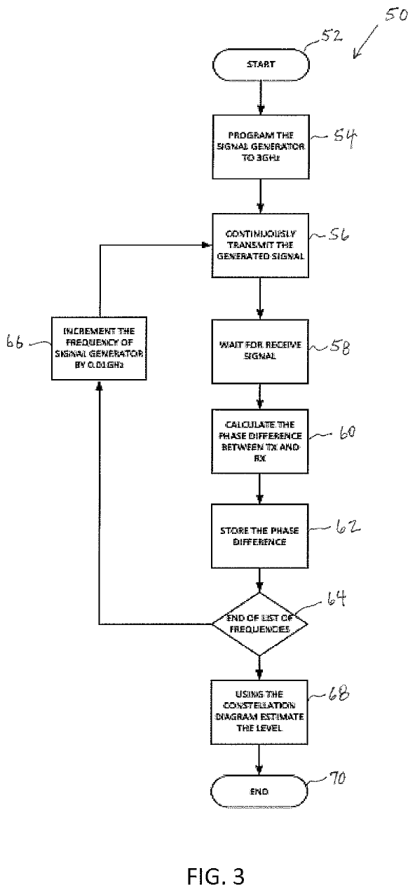

Turning now to FIG. 3, and with continued reference to FIGS. 1 and 2, a method according to the present disclosure is illustrated using a flow diagram 50. The method begins at a START, at box 52. At box 54, the programmable frequency generator 22 is programmed to generate a signal having a predetermined frequency. The signal having the predetermined frequency is transmitted, as transmitting signal 24, toward the medium 4 using the transmit antenna 28, at box 56. At box 58, the transmitting signal 24, which may be transmitted continuously, may be received by receive antenna 34 as the reflected signal 36. The reflected signal 36 may be a return signal, or echo signal, that is reflected or redirected off the surface 12 of the medium 4.

The phase detector 30 receives the reflected signal 36 and compares the phase of the transmitting signal 24 to the phase of the reflected signal 36, at box 60, to arrive at the phase difference 38. The phase difference 38 may be transmitted to, stored in, and/or accessible by the controller 20 (box 62). According to an exemplary embodiment, a predetermined set, or range, of frequencies may be used to determine the level of the medium 4 in the container 6. As such, it may be determined at box 64 whether signals having each of the predetermined frequencies have been transmitted. If not, the frequency of the programmable frequency generator 22 may be incremented and the method steps at box 56 through box 64 may be repeated (box 66).

When signals having the predetermined set of frequencies have been generated, the method proceeds to box 68, in which the level of the medium 4 is determined based on the frequencies and the phase differences. The level may be determined using the controller 20, for example, and may or may not utilize a reference table that includes mappings of medium levels to frequencies and phase differences. For example, a constellation diagram may be used or accessed to identify the level. After the medium level has been determined, the method proceeds to an END, at box 70.

According to one embodiment, a frequency range utilized by the system 2 may include 3 GHz through 3.25 GHz. However, various frequency ranges may be utilized and, further, any number of different frequencies may be utilized. Desired level accuracy may dictate the frequency range and number of predetermined frequencies used. Various other factors may dictate the frequencies that are used. For example, a 4-20 mA loop may be used, with lower power dictating a lower frequency range. The system 2 and method disclosed herein may be used to monitor level and communicate the level to any number of different devices.

While various embodiments have been described in considerable detail herein, the embodiments are merely offered by way of non-limiting examples of the disclosure described herein. It will therefore be understood that various changes and modifications may be made, and equivalents may be substituted for elements and steps thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Such sequences may be varied and still remain within the scope of the present disclosure. Therefore, the particular order of the steps disclosed herein should not be construed as limitations of the present disclosure.

What is claimed is:

1. A method for determining a level of a medium in a container, including steps of:
generating a first transmitting signal having a first predetermined frequency;
transmitting the first transmitting signal toward the medium such that the first transmitting signal is reflected from the medium;
receiving a first reflected signal from the medium that corresponds to the first transmitting signal;
determining a phase difference between a phase of the first transmitting signal and a phase of the first reflected signal; and
determining the level of the medium based on the first predetermined frequency and the phase difference.

2. The method of claim 1, further including:
generating a set of transmitting signals having a range of different frequencies;
transmitting the set of transmitting signals toward the medium such that the set transmitting signals is reflected from the medium;
receiving a set of reflected signals from the medium that correspond to the set of transmitting signals;
determining phase differences between phases of the set of transmitting signals and phases of corresponding signals of the set of reflected signals; and
determining the level of the medium based on the range of different frequencies and the phase differences.

3. The method of claim 1, further including:
receiving the first transmitting signal as a first reference signal at a phase detector; and
determining the phase difference by comparing the phase of the first reference signal and a phase of the first reflected signal at the phase detector.

4. The method of claim 2, wherein generating the set of transmitting signals includes generating a set of radio-frequency signals.

5. The method of claim 4, further including performing the method at predetermined time intervals.

6. The method of claim 4, wherein determining the level of the medium includes selecting a level value from a reference table that includes mappings of medium levels to frequencies and phase differences.

7. A system for determining a level of a medium in a container, including:
a frequency generator for generating a first transmitting signal having a first predetermined frequency;
a transmitter for transmitting the first transmitting signal toward the medium;
a phase detector for receiving the first transmitting signal as a first reference signal;
a receiver for receiving a first reflected signal from the medium that corresponds to the first transmitting signal;
the phase detector configured to determine a phase difference between a phase of the first reference signal and a phase of the first reflected signal; and
a controller for determining the level of the medium based on the first predetermined frequency and the phase difference.

8. The system of claim 7, further including:
the frequency generator configured for generating a set of transmitting signals having a range of different frequencies;
the transmitter configured for transmitting the set of transmitting signals toward the medium;
the phase detector configured for receiving the set of transmitting signals as reference signals;
the receiver configured for receiving a set of reflected signals from the medium that correspond to the set of transmitting signals;
the phase detector configured for determining phase differences between phases of the set of reference signals and phases of the set of reflected signals; and
the controller configured for determining the level of the medium based on the range of different frequencies and the phase differences.

9. The system of claim 7, further including:
the phase detector receiving the first transmitting signal as a first reference signal; and
the phase detector determining the phase difference by comparing the phase of the first reference signal and a phase of the first reflected signal.

10. The system of claim 9, wherein the frequency generator is configured to generate radio-frequency signals.

11. The system of claim 9, wherein the frequency generator is configured to generate the radio-frequency signals at predetermined time intervals.

12. The system of claim 10, further including a memory, wherein the memory is accessible by the controller and stores a reference table including mappings of medium levels to frequencies and phase differences.
